(19) United States
(12) Patent Application Publication
(10) Pub. No.: US 2010/0224723 A1
(43) Pub. Date: Sep. 9, 2010

(54) AERIAL VEHICLE

(76) Inventor: Jacob Apkarian, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/396,738

(22) Filed: Mar. 3, 2009

(51) Int. Cl. B64C 39/00

(52) U.S. Cl. 244/65

(57) ABSTRACT

Various embodiments of an aerial vehicle with propulsion system and a protective frame is disclosed. The propulsion system has an air intake side and air outlet side. The protective frame surround both the intake and outlet side of the propulsion system to protect at least some components of the propulsion system from obstacles and other aerial vehicles. In some embodiments, the propulsion system includes one or more rotors or propellers. In some embodiments, protective frame also surrounds the radial ends of the rotor or propeller.

### FIELD

This invention relates to aerial vehicles.

### BACKGROUND

Aerial vehicle have many uses. For example, aerial vehicles may be used as toys, research tools and as monitoring and surveillance tools. Some known aerial vehicles have a rotary propulsion system that provides lift by forcing air generally downwards relative to the vehicle. For example, the propulsion mechanism may have a propeller or rotor that draws air from an air inlet side of the propulsion mechanism and blows the air out at an air outlet side of the propulsion mechanism.

Some known aerial vehicles with such a rotary propulsion system have a radial protective element that surrounds the rotary moving parts of the propulsion system adjacent it radial outer edge. While this provides some limited protection inhibiting impact with the tip of the rotary moving parts, it does not at all inhibit contact with the rotary moving elements from the air inlet or air outlet sides of the rotary propulsion system.

An aerial vehicle with an improved protective system is desirable.

### SUMMARY

A first aerial vehicle according to the present invention includes: a powered propulsion system having an air intake side and an air outlet side, wherein the powered propulsion system includes a rotor or propeller; and a protective frame that surrounds the air intake side and the air outlet side.

In some embodiments, the rotor has blades extending radially from an axis and having radial ends and wherein the frame includes a radial protection section for protecting the radial ends of the rotor.

In some embodiments, the radial protection system radially surrounds the propeller.

In some embodiments, the propulsion system has a center position and a plurality of other positions and wherein the radial protection section protects the radial ends of the rotor or propeller in the central position and in the plurality of other positions.

In some embodiments, the protective frame generally has a shape selected from the group consisting of: a spheroid; a sphere; a prolate sphere; an oblate sphere; a disc; an ovoid, a parallelopiped; and a closed ended cylinder.

In some embodiments, the protective housing includes an intake protection section, wherein at least part of the intake protection section is aligned with at least part of the air intake side.

In some embodiments, the intake protection section has a shape selected from the group consisting of: hemisphere; a part of sphere; part of an oblate spheroid; a capped cylinder; a toroid; and a parallelopiped.

In some embodiments, the protective housing includes an outlet protection section, wherein at least part of the outlet protection section is aligned with at least part of the air outlet side.

In some embodiments, the outlet protection section has a shape selected from the group consisting of: hemisphere; a part of sphere; part of an oblate spheroid; a capped cylinder; a toroid; and a parallellopiped

Some aerial vehicle according to the invention include a powered propulsion system having an air intake side and an air outlet side; a protective frame having an intake protection section, an outlet protection section and a central protection section between the intake protection section and the outlet protection section, wherein at least part of the intake protection section is aligned with at least part of the air intake side and wherein at least part of the outlet protection section is aligned with at least part of the outlet side.

In some embodiments, the intake protection section is shaped as part of a sphere.

In some embodiments, the outlet protection section is shaped as part of a sphere.

In some embodiments, the propulsion system includes a propeller that can operate in a plurality of positions including a center position and wherein at least part of the central protection section is aligned with the center position.

In some embodiments, the plurality of positions includes one or more lateral motion positions and wherein the aerial vehicle includes a flight control system for moving the propeller between the zero-wind hovering position and the lateral movement positions.

### BRIEF DESCRIPTION OF THE DRAWINGS

Several embodiments of the present invention will now be described in detail with reference to the drawings. Corresponding elements in different drawings are identified by corresponding reference numerals. In the drawings:

FIGS. 1, 2a and 2b illustrate a first embodiment of an aerial vehicle according to the invention;

FIG. 3 illustrates a control assembly of the aerial vehicle; and

FIGS. 4, 5, 6, 7 and 8 illustrate other aerial vehicles according to the invention.

### DETAILED DESCRIPTION OF EXEMPLARY EMBODIMENTS

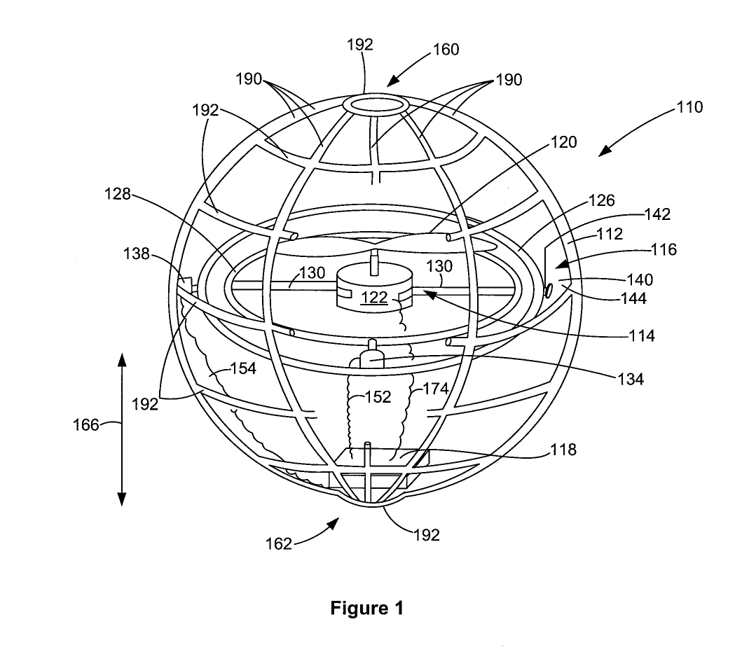

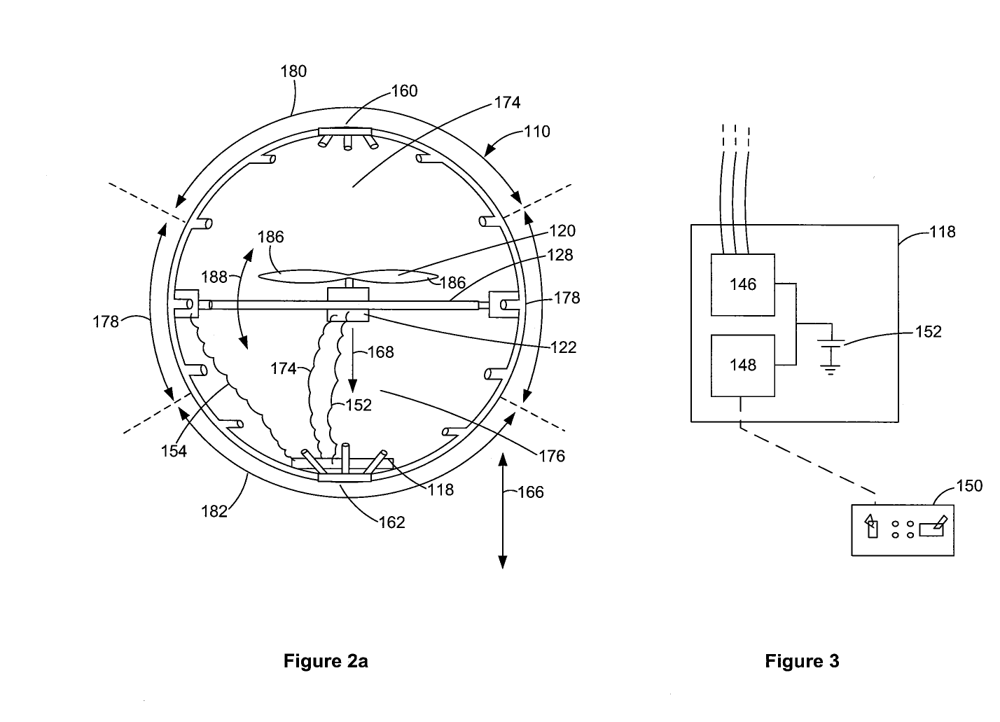

Reference is first made to FIGS. 1, 2a and 2b, which illustrates an aerial vehicle 110 according to one embodiment of the invention. The aerial vehicle 110 includes a frame or housing 112, a propulsion system 114, a propulsion system mount 116 and a control assembly 118.

In this embodiment, the propulsion system 114 includes a rotor 120 and a motor 122. The rotor 120 is coupled to the motor 122 through a rotor shaft 124. The propulsion system 114 is mounted to the frame 112 through the propulsion system mount 116. Propulsion system mount 116 includes a pair of gimbals 126, 128. Motor 134 is mounted to gimbal 126 through a pair of mounting bars 130 to hold the motor in a fixed position relative to gimbal 126. Gimbal 126 is coupled to gimbal 128 through an actuator 134 and a rotational coupling 136, which is concealed by the motor 122 in FIGS. 1a and 1b. Gimbal 128 is coupled to frame 112 through an actuator 138 and a rotational coupling 140. Rotational couplings 136 and 140 may be any type of rotational coupling that permits the coupled elements to rotate relative to one another. For example, rotational coupling 140 includes a shaft 142 that is fixed to gimbal 128 and a bearing mount 144 that is fixed to frame 112. The shaft 142 and the mount 144 are coupled by a bearing (not shown) allowing them to rotate relative to one another.

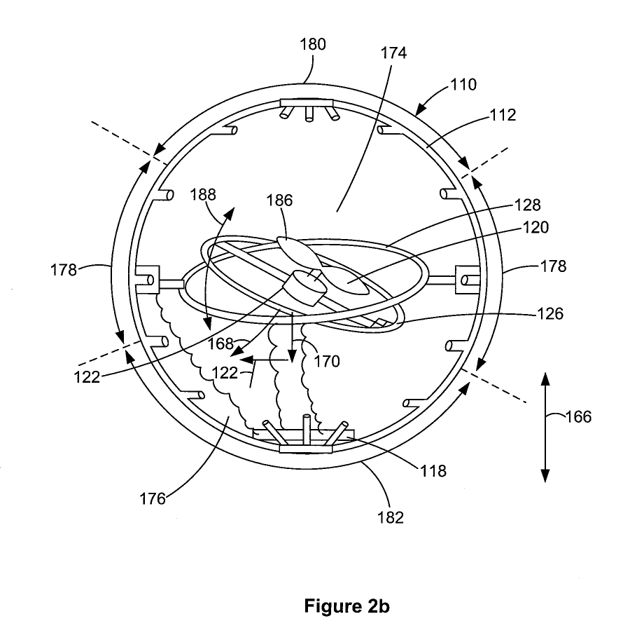

The control assembly 118 is fixedly mounted to the frame 112. Referring to FIG. 3, the control unit comprises a controller 146 and a wireless communication unit 148 and a power source 152. The wireless communication unit 148 communicates wirelessly with a remote control unit 150. In the present embodiment, the remote control unit 150 is a handheld device and includes control devices, such as control knobs and sliders, for adjusting the flight of aerial vehicle 110. In this example embodiment, remote control unit 150 transmits radio frequency flight control signals based on the position of the control devices. A user can hold the remote control unit 150 and manipulate the control devices, thereby varying the flight control signals transmitted by the remote control unit 150. Wireless communication unit 148 receives the flight control signals and provides the flight control signals, or a modified version of the flight control signals, to the controller 146.

The controller 146 and the wireless communication unit 148 are coupled to the power source 152 to receive power. Typically, the power source 152 will be a battery.

It is desirable to maintain the aerial vehicle 110 in a generally vertical position during flight, with the top 162 of the aerial vehicle pointing upwards and the bottom 160 of the aerial vehicle pointing down towards the ground (not shown). The orientation of aerial vehicle 110 may be defined by a line running through the top 162 and bottom 160 of the aerial vehicle. The aerial vehicle 110 is in a vertical orientation when its orientation is parallel to the vertical direction. The force of gravity effectively defines the vertical direction 166. The orientation of aerial vehicle 110 will be generally vertical during flight, in that the orientation will typically be at an angle of less than 20° to the vertical direction 166.

The control assembly 118 is mounted to the frame 112 at the bottom 160 of the frame 112. In this embodiment, control assembly 118 provides a mass at the bottom of frame 112 to assist in retaining aerial vehicle 110 in a generally vertical orientation. In other embodiments, the control assembly may be mounted elsewhere on the frame 112 and a separate mass may be provided to assist in retaining the aerial vehicle in a vertical orientation. The separate mass may be mounted at one point of the frame 112. For example, the separate mass may be mounted at the bottom 160 of the aerial vehicle. In other embodiments, the separate mass may be positioned such that the center of mass of the aerial vehicle lies on the line between the top 162 and bottom 160 of the aerial vehicle 110. In other embodiments, the aerial vehicle may include two or more masses mounted to the frame 112 to assist in retaining the aerial vehicle in a vertical orientation.

Controller 146 is coupled to actuators 134 and 138 through wires 152 and 154. Controller 145 transmits actuator control signals to the actuators 134 and 138 in response to the flight control signals. Actuators 134 and 138 rotate gimbals 126 and 128 in response to the actuator control signals, thereby moving the propulsion system 114 relative to the frame 112.

In aerial vehicle 110, controller 146 is coupled to motor 134 through wires 174. Controller 146 transmits motor control signals to motor 134 to control the rotation of rotor 120.

Reference is made to FIGS. 2a and 2b, which illustrate aerial device 110 with the propulsion system 114 in several positions relative to the frame 112.

In FIG. 2a, the aerial vehicle is illustrated with the propulsion system in a hovering, ascending or descending position. In this position, the aerial vehicle is in a vertical orientation and the propulsion system generates a downward propulsion force 168 that provides lift to the aerial vehicle 110.

The aerial vehicle 110 may ascend, hover and descend depending on whether the amount of lift generated. The propulsion force 168 does not cause the aerial vehicle 110 or move sideways or laterally relative to the vertical direction 166. The propulsion force 168 is generated in a downward in the vertical direction. The position of the propulsion system 114 when such a downward propulsion force is generated may be referred to as a horizontal position, a center position or a zero-wind hovering position.

In the absence of any force other than the propulsion force and gravity acting on the aerial vehicle 110, the rotor 120 will rotate in a plane that is normal to the vertical direction when the propulsion system in the center position.

In FIG. 2b, the aerial vehicle is illustrated with propulsion system 114 in a lateral movement position. In response to actuator control signals, actuators 134 and 138 have positioned the propulsion system 114 so that the rotor 120 is tilted at an angle α relative to the center position illustrated in FIG. 2a. Propulsion force 168 is generated at an angle β to the vertical direction 166. (The tilt of the rotor will typically cause some tilting, or pitch, of the frame 112. As a result, the angles α and β will typically not be identical, although they may be similar.) The propulsion force 168 can be resolved into a lift vector 170 and a lateral movement vector 172. In the absence of any force other than the propulsion force 168 and gravity, the aerial vehicle will move laterally in a direction opposite to the lateral movement vector 172.

In aerial vehicle 110, the control assembly 118 and the gimbal mount of the propulsion system 114 to the frame 112 form a flight control system.

In aerial vehicle 110, the propulsion system has numerous lateral movement positions. When the propulsion system 114 is in the horizontal or center position as in FIG. 2a, the rotor 120 rotates in a horizontal plane that is normal to the vertical direction. In aerial vehicle, each of actuators 134, 138 may rotate up to 20° in each direction from the actuator's position in this center position. Each actuator may be set in one of 256 positions by the controller 146. When each actuator rotates, the corresponding gimbal also moves to a corresponding position. The center position in approximately in the middle of the 256 positions in which each actuator may be set and accordingly, the center position is approximately in the middle of the 40° range of rotation for each gimbal. The propulsion system 114 has a lateral movement position corresponding to every combination of positions in which the two gimbals 126, 128, with the exception of the combination corresponding to the center position. The ±20° rotation range of the rotor 120 is illustrated by arc 188.

In other embodiments, the actuators 134, 138 may rotate through a range of greater or less than 20° from the actuators center position, and may have any number of positions in which the actuators can be positioned through their respective ranges of motion.

In aerial vehicle 110, lift is generated when rotor 120 rotates in response to motor control signals received by motor 122 from controller 146. The rotor draws air from an air intake side 174 and expels the air on an air outlet side 176 of the rotor 120. The air intake side 174 and air outlet side 176 rotate relative to frame 112 when the rotor is moved to different positions.

FIGS. 2a and 2b illustrate three regions of the frame 112. The frame 112 has a radial protection section 178, an intake protection section 180 and an outlet protection 182. Intake protection section 180 protects (at least to some extent) at least part of the air intake side 174 of the rotor 120. Outlet protection section 182 protects (at least to some extent) at least part of the air outlet side 176 of the rotor 120. The radial protection section 178 protects the radial ends 186 of the rotor blades 184 of rotor. As shown in FIG. 2b, the radial protection section 178 radially surrounds the rotor 184 in any lateral movement position.

In aerial vehicle 110, the propulsion system 114 includes a single rotor 120. The rotation of the rotor 120 may cause a reactive rotation of the frame 112.

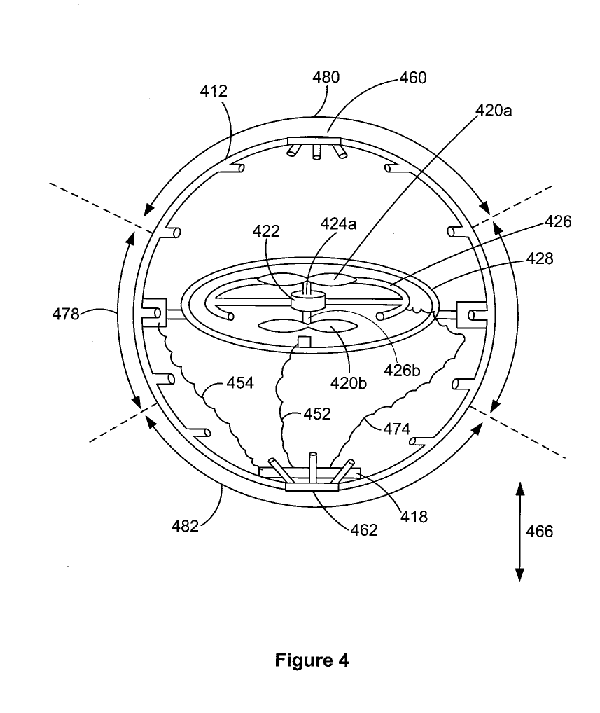

Reference is next made to FIG. 4, which illustrates another aerial vehicle 410. In aerial vehicle 400, the propulsion system 414 includes a pair of counter-rotating rotors 420a and 420b. Each of the rotors is coupled to the motor 422 through a rotor shaft 424a, 424b. The motor 422 rotates the two rotor at an equal number of rotations per minute but in opposite directions. The two rotors apply an approximately equal rotation force to the frame 412, but in opposite directions. The two forces effectively cancel one another substantially preventing the frame from rotating in response to the rotation of the rotors 420.

In aerial vehicle 420, the radial protection region 478 surrounds both rotors 420 as they tilt relative to frame 412 to the central and lateral movement positions. In their central position, the rotors 420 are equally spaced from a central horizontal plane 490 of the frame 412. The radial protection section 478 of the frame includes a horizontally central portion of the frame 412. The intake protection region 480 and the outlet protection region 482 are essentially symmetrical.

Reference is again made to FIG. 1. In aerial vehicle 110, the frame 112 is made of wire elements that are joined together to including a plurality of longitudinal elements 190 and a plurality of latitudinal elements 192. (Only some of the elements 190, 192 are shown. Elements on the rear side (from the perspective of FIG. 1 are not shown to simplify the Figures.) In any particular embodiment, these elements may be welded, glued, tied, screwed or otherwise fastened together. In other embodiments, the frame may be formed of plastic, wood, metal or elements. The frame may be formed as two or more elements, by molding, for example, which are then assembled together or it may be formed of a larger number of individual elements.

The wire or other elements of the frame 112 provide a protective shield around the propulsion system 114, reducing the likelihood that an object will come into contact with the rotor 120. The spacing of the elements of frame 112 will depend on the desired degree of protection. For example, the elements of frame 112 may be spaced such that no part of another similar vehicle could come into contact with the rotor 120 when the two aerial vehicles are in contact. In other embodiments, the spacing between the elements of the frame 112 may be smaller to increase the degree of protection or larger if such protection is not required. Different sections, regions or areas of the frame 112 may have different spacing between elements of the frame.

The various elements 190, 192 of the frame do not clear identify the boundaries of the intake protection section 180, the radial protection section 178 and the outlet protection section 182. In other embodiments, different sections of the frame may be assembled differently from one another.

In aerial vehicle 110, the frame 112 is generally spherical. In other embodiments, the frame 112 may take other shapes.

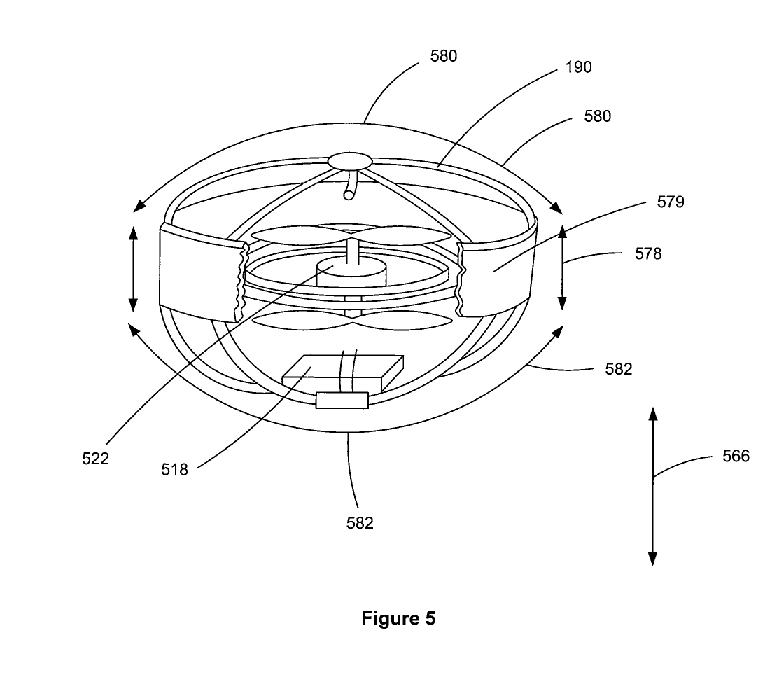

Reference is next made to FIG. 5, which illustrates another aerial vehicle 510. In aerial vehicle 510, the radial protection section 578 is formed of a generally tubular ring 579. The intake protection section 580 and the outlet protection section 582 are flattened domes. In other embodiments, the intake protection section or the outlet protection section may be shaped as part of a sphere, part of an oblate spheroid, part of a prolate spheroid, a dome, a flattened dome or any other shape. The inlet and outlet protection sections of the frame 512 in each embodiment will be air permeable to permit air to be drawn and expelled by the rotor through air intake and air outlet sides.

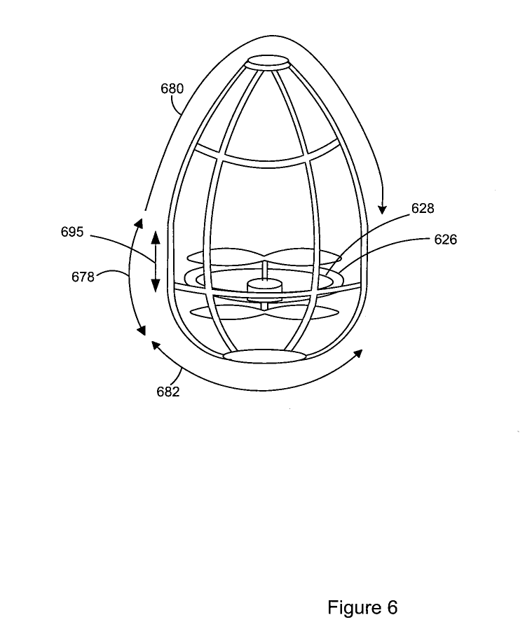

Reference is next made to FIG. 6, which illustrates another aerial vehicle 610. In aerial vehicle 610, the radial protection section 678 is not delimited from the intake protection section 680 and the outlet protection section 682 by the physical structure of frame 612. The intake protection section 680 is shaped as part of a prolate spheroid. The outlet protection section is shaped as a part of an oblate spheroid that has been flattened on its bottom side 694. The flat bottom side 694 allows the aerial vehicle to rest on its bottom when it is not in flight. Aerial vehicle 610 illustrates that the different sections of the frame may have different shapes or may be based on different shapes. Aerial vehicle 610 also illustrates that the different sections need not have a single geometric shape. The radial protection section 678 has a cylindrical portion 695 and portions that transition to the shapes of the inlet protection section 680 and the outlet protection section 682. The inlet and outlet protection section may similarly have differently shaped portions in different embodiments.

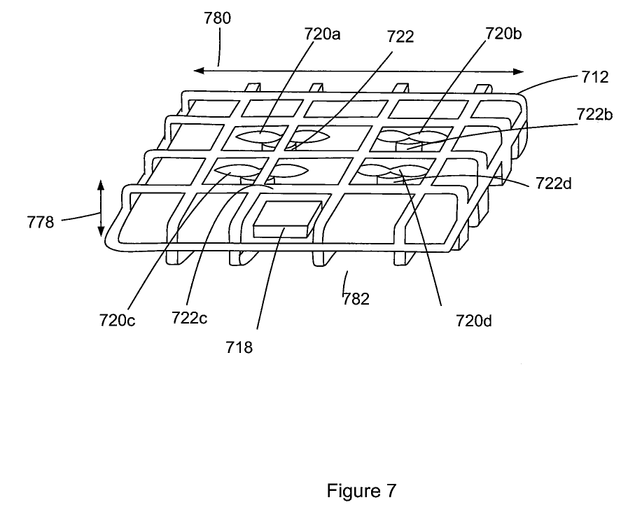

Reference is next made to FIG. 7, which illustrates another aerial vehicle 710. The propulsion system 714 includes four rotors 720 positioned on a common plane. Each rotor has its own motor 722. The propulsion system is fixedly mounted to the frame 712. Control assembly 718 includes a controller (now shown) that sends flight control signal to each of the motors 722 and can independently control each of the motors 722 and the lift provided by each of the rotors 720. Each rotor 720 contributes a component to the propulsion force 768. By varying the component contributed to the propulsion force by each rotor 720, the aerial vehicle 710 can be made to ascend, descend or move laterally. The rotors 720 may spin in different directions to avoid or reduce imparting a rotational moment to the frame 712. For example, rotors 720a and 720c may spin in a clockwise direction while rotors 720b and 720d may spin in a counter-clockwise direction.

Aerial vehicle also illustrates that the frame 712 may have any shape that provides a radial protection section 778, an inlet protection section 780 and an outlet protection 782. The frame 712 and its sections need not have any symmetry such as the rotational symmetry of frames 112, 512 and 612. Typically, although not necessarily, the shape of the frame will be based on the size and arrangement of the components of the propulsion system.

Referring again to FIG. 4, flight of the aerial vehicle is controlled by controlling the pitch and yaw angles of the rotor 420, by controlling the angular positions of the gimbals 426, 428.

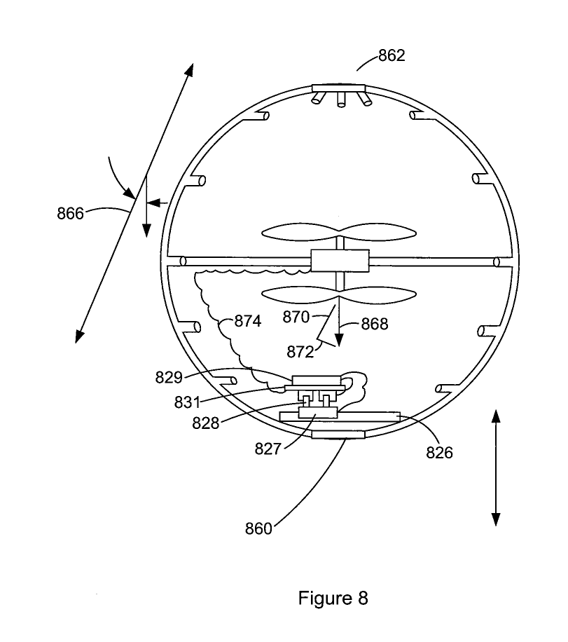

Reference is next made to FIG. 8, which illustrates another aerial vehicle 810 according to the present invention. The propulsion system 814 is fixedly attached to the frame 812. The control assembly 818 acts as a mass to assist in retaining aerial vehicle 810 in an upright orientation.

A first pair of slide supports 826 are mounted to the frame 812. A second pair of slide supports 828 are mounted on supports 826 through travelers 827, which allow the second pair of brackets 828 to move along the supports 826. A mounting bracket 829 is mounted to second pair of supports through travelers 831. The control assembly 818 is mounted to bracket 829. Controller 846 is coupled to travelers 827 and 831 to control the position of the bracket 829 relative to the frame 812. Travelers 827 and 831 may be configured such that can be positioned at any point along their respective supports, along the control assembly to be moved in two directions X and Y relative to the frame.

When the control assembly 818 is moved relative to the frame, its shifting mass will change the center of mass of the entire aerial vehicle 810 and the entire aerial vehicle will adopt a different vertical orientation. When the control assembly is displaced from its center position, in which its balanced along a line between the top 862 and bottom 860 (assuming that the control assembly and the rest of the aerial vehicle both have a centre of mass along that line when in the center position), the aerial vehicle pitches at an angle β from a vertical orientation. The pitch angle β will depend on the mass of the control assembly (including any deadweight added to the control assembly to increase the total mass on the bracket 829) and its displacement from the centre of the aerial vehicle.

When the aerial vehicle is pitched at an angle β, the propulsion force is generated at an angle β from the vertical direction 866, providing both a lift vector 870 and a lateral movement vector 872. By controlling the position of the control assembly and the strength of the propulsion force (which is controlled by the spin rate of the rotor 820), the flight of aerial vehicle 810 may be controlled. The control assembly and the sliding mount system of the control assembly 818 to the frame 812 acts as a flight control system. By changing the position of the control assembly, the flight of the aerial vehicle is controlled.

In other embodiments, a mass independent of the control assembly may be mounted on the bracket 829 and be moved relative to the frame 812. The control assembly may be mounted in a fixed position relative to the frame 812 and it may control the flight of such an aerial vehicle by controlling the position of the independent mass.

Referring again to FIG. 1, it is possible that the rotation of the rotor 120 can impart a rotational moment to the frame 112, causing the entire aerial vehicle 110 to spin in a direction opposite to the spin of rotor 120. Referring to FIG. 2, this problem is addressed in aerial vehicle 210 by adding a second rotor 220b that rotates in the opposite direction from rotor 220a. In other embodiments, anti-torque vanes may be used to direct the expelled air from the propeller 120 to ensure that propulsion force does not have an angular component and to thereby reduce any rotation moment imparted to the frame 112. In some embodiments, an anti-torque rotor may be added to the propulsion system to generate an anti-torque force at an angle to the propulsion force (typically at about 90° to the propulsion force). The control system also controls the anti-torque rotor to prevent the aerial vehicle from undesirably spinning.

The present invention has been described here by way of example only. Various modifications and variations may be made to these exemplary embodiments without departing from the spirit and scope of the invention, which is limited only by the appended claims.

What is claimed is:

1. An aerial vehicle comprising:
a powered propulsion system having an air intake side and an air outlet side, wherein the powered propulsion system includes a rotor; and
a protective frame that surrounds the air intake side and the air outlet side.

2. The aerial vehicle of claim 1 wherein the rotor has blades extending radially from an axis and having radial ends and wherein the frame includes a radial protection section for protecting the radial ends of the rotor.

3. The aerial vehicle of claim 2 wherein the radial protection system radially surrounds the propeller.

4. The aerial vehicle of any one of claims 2 or 3 wherein the propulsion system has a center position and a plurality of other positions and wherein the radial protection section protects the radial ends of the rotor in the central position and in the plurality of other positions.

5. The aerial vehicle of any one of claims 1 to 4 wherein the protective frame generally has a shape selected from the group consisting of:
a spheroid;
a sphere;
a prolate sphere;
an oblate sphere;
a disc;
an ovoid
a parallelopiped; and
a closed ended cylinder.

6. The aerial vehicle of any one of claims 1 to 4 wherein the protective housing includes an intake protection section, wherein at least part of the intake protection section is aligned with at least part of the air intake side.

7. The aerial vehicle of claim 6 wherein the intake protection section has a shape selected from the group consisting of:
hemisphere;
a part of sphere;
part of an oblate spheroid;
a capped cylinder;
a toroid; and
a parallelopiped.

8. The aerial vehicle of any one of claim 1 to 4, 6 or 7 wherein the protective housing includes an outlet protection section, wherein at least part of the outlet protection section is aligned with at least part of the air outlet side.

9. The aerial vehicle of claim 6 wherein the outlet protection section has a shape selected from the group consisting of:
hemisphere;
a part of sphere;
part of an oblate spheroid;
a capped cylinder;
a toroid; and
a parallelopiped.

10. An aerial vehicle comprising:
a powered propulsion system having an air intake side and an air outlet side;
a protective frame having an intake protection section, an outlet protection section and a central protection section between the intake protection section and the outlet protection section,
wherein at least part of the intake protection section is aligned with at least part of the air intake side and wherein at least part of the outlet protection section is aligned with at least part of the outlet side.

11. The aerial vehicle of claim 10 wherein the intake protection section is shaped as part of a sphere.

12. The aerial vehicle of claim 10 wherein the outlet protection section is shaped as part of a sphere.

13. The aerial vehicle of claim 10 wherein the propulsion system is a propeller that can operate in a plurality of positions including a center position and wherein at least part of the central protection section is aligned with the center position.

14. The aerial vehicle of claim 13 wherein the plurality of positions includes one or more lateral motion positions and wherein the aerial vehicle includes a flight control system for moving the propeller between the zero-wind hovering position and the lateral movement positions.
